(19) United States
(12) Patent Application Publication
(10) Pub. No.: US 2008/0061939 A1
(43) Pub. Date: Mar. 13, 2008

(54) Method and apparatus for determining ordering of RFID tagged objects

(76) Inventors: John S. Davis, New York, NY (US); Johnathan M. Reason, Port Chester, NY (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/496,898

(22) Filed: Aug. 1, 2006

(51) Int. Cl. H04Q 5/22

(52) U.S. Cl. 340/10.1; 340/572.4; 340/539.13; 340/825.49; 340/5.61; 342/47

(57) ABSTRACT

The invention addresses the disadvantage of RFID scanning by maintaining the relative physical order of tags simultaneously scanned. The novelty of the invention includes a forwarding mechanism applied to the RFID tags and an aggregation of the received tag information. The received information is then used to calculate relative ordering information. Our system leverages both reader-to-tag and tag-to-tag communication. Each tag in the invention can measure the received signal strength and the ID of the sender. Tags respond to received signals by transmitting their ID and a payload consisting of the ID & signal strength of the previous sender as well as the payload received from the previous sender. The reader then aggregates this information from which is calculated the relative physical ordering of the tags based on the aggregated information.

### FIELD OF THE INVENTION

The present invention generally relates to a method and system to determine the ordering of radio frequency identification (RFID) tagged objects; and, more particularly, to a method and system that transforms wireless measurements from RFID tagged objects into a logical topology that represents the ordering of the RFID objects in the physical world.

### BACKGROUND OF THE INVENTION

RFID is a technology that employs tags (e.g., wireless radio transponders), attached to a material or object (e.g., a shipping package). The tag sends information stored on the tag in response to a radio signal sent from a reader, which reads the information and forwards it to other systems for subsequent processing. Passive tags do not include an energy source (e.g., a battery) for the transmitter, but instead send their information as they reflect the radio signal energy received from the reader back to the reader. Active tags do include an energy source and, subsequently, have a longer transmission range than passive tags. Tags that have a passive transmitter, but also include a battery to power memory or other circuitry are called semi-passive or semi-active.

In logistics applications, tags are attached to objects (or materials) and detected by stationary readers to support automated material identification and tracking. In general, tagged objects may include inanimate objects such as pallets, cases, and individual retail items but may also include vehicles, people, animals, etc.

RFID scanning is thought to be a replacement for barcode scanning, which is currently in widespread use. RFID scanning has the distinct advantage (among other advantages) that multiple items can be simultaneously scanned which improves speed and potentially reduces costs. However, the disadvantage of such quick scanning is that information about the physical order of RFID tagged objects is lost, since objects are no longer scanned one at a time, as with barcode scanning. Preserving the order of RFID tagged objects is vital to many potential applications of RIFD, including auto-routing of packages, auto-payment systems, etc.

The conventional approach to addressing this disadvantage is to physically adjust the RFID apparatus and/or the RFID tagged objects, such that only one object is in the field-of-view (FOV) of the RFID reader at any given time. This approach is not robust and is prone to error.

### SUMMARY OF THE INVENTION

The invention addresses this disadvantage of RFID scanning by maintaining the relative physical order of tags simultaneously scanned. The invention includes a forwarding mechanism applied to the RFID tags and an aggregation of the received tag information. The received information is then used to calculate relative ordering information.

Our system leverages both reader-to-tag and tag-to-tag communication. Each tag in the invention can measure the received signal strength and the ID of the sender. Tags respond to received signals by transmitting their ID and a payload consisting of the ID & signal strength of the previous sender as well as the payload received from the previous sender. The reader then aggregates this information from which is calculated the relative physical ordering of the tags based on the aggregated information.

For example, in one aspect of the invention, two or more RFID tagged objects will be scanned by a single reader and upon reception of the reader's signal, the RFID tags will transmit responses that are aggregated by the reader and used to determine the relative physical locations of the RFID tagged objects with respect to the reader. An exemplary use of the invention is a supply chain conveyor belt carrying RFID tagged objects that are scanned by an RFID reader for selection on the conveyor belt. An exemplary use of the invention is a retail store shelf in which the RFID tagged items on the shelf are scanned by an RFID reader to determine the orientation of items on the shelf with respect to the expiration dates of the items.

### DESCRIPTION OF THE RELATED ART

Prior to the present invention, there existed no low-complexity technique that provides the relative physical order of simultaneously read RFID tags. All of the following are incorporated by reference. In particular, U.S. Patent Application 2005/0067492 shows a personal index of items in physical proximity to a user. In particular, U.S. Patent Application 2004/0169587 shows systems and methods for location of objects. In particular, U.S. Patent Application 2004/0021572 shows an electronic baggage tracking and identification. In particular, U.S. Patent Application 2003/0146835 shows an object location monitoring within buildings. In particular, U.S. Patent Application 2002/0149483 shows a method, system, and apparatus for communicating with a RFID tag. In particular, U.S. Pat. No. 6,563,425 (Nicholson et al) “RFID Passive Repeater System and Apparatus” uses a repeater that is not a tag; this extends the reach of the reader but it does not aggregate the data (particularly not in terms of ordering the data).

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is an illustration of an exemplary use of this invention in which RFID tagged objects on a conveyor belt are scanned by an RFID reader;

FIG. 2 is a block diagram of an exemplary use of this invention in which two RFID tagged objects are scanned by an RFID reader;

FIG. 3 is an illustration of exemplary message communication between three RFID tagged objects;

FIG. 4 is an illustration of an exemplary method for specifying the payload of tag to tag communication between RFID tagged objects; and

FIG. 5 is a flow diagram illustrating the methodology for aggregating RFID tag data received by a reader to determine physical ordering of the RFID tagged objects.

### DETAILED DESCRIPTION OF EXEMPLARY EMBODIMENTS OF THE INVENTION

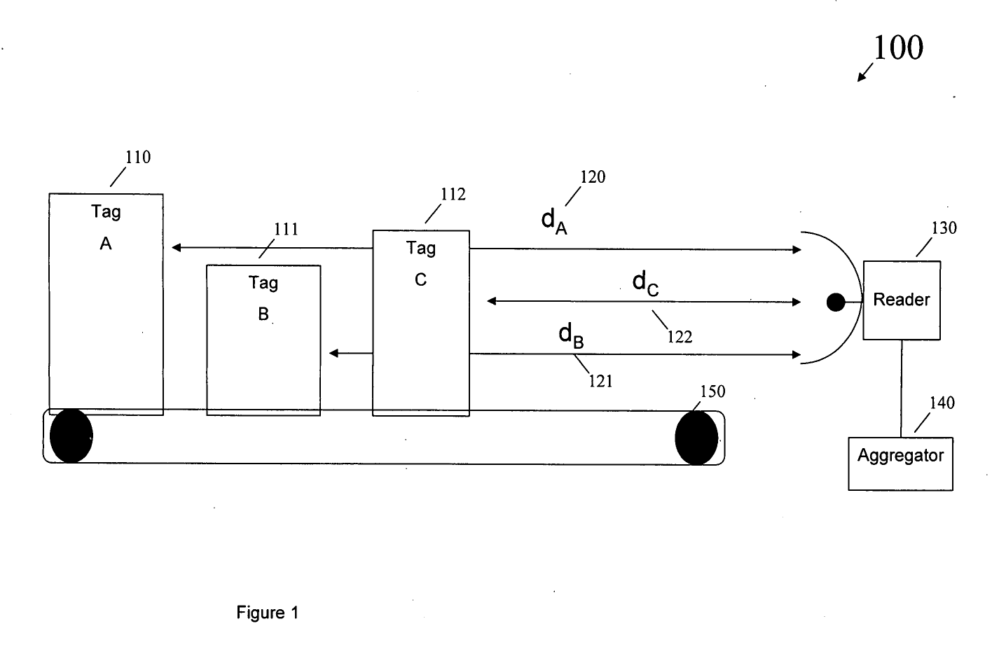

Referring now to the drawings, and more particularly to FIGS. 1-5, we describe exemplary embodiments of the method and structures according to the present invention.

FIG. 1 100 displays one possible embodiment of the present invention. FIG. 1 displays a conveyor belt layout involving passive RFID tags 110, 111, 112 on a conveyor belt 150. A reader (transceiver) 130 sends a signal to each of the tags as they move along the conveyor belt. The distance between the reader and tag A 110 is denoted d_{A} 120. The distance between the reader and tag B 111 is denoted d_{B} 121. The distance between the reader and tag C 112 is denoted d_{C} 122. The reader is connected to an aggregator (processor, calculator) 140 that calculates the relative positions of the tags after the reader has received the tag signals.

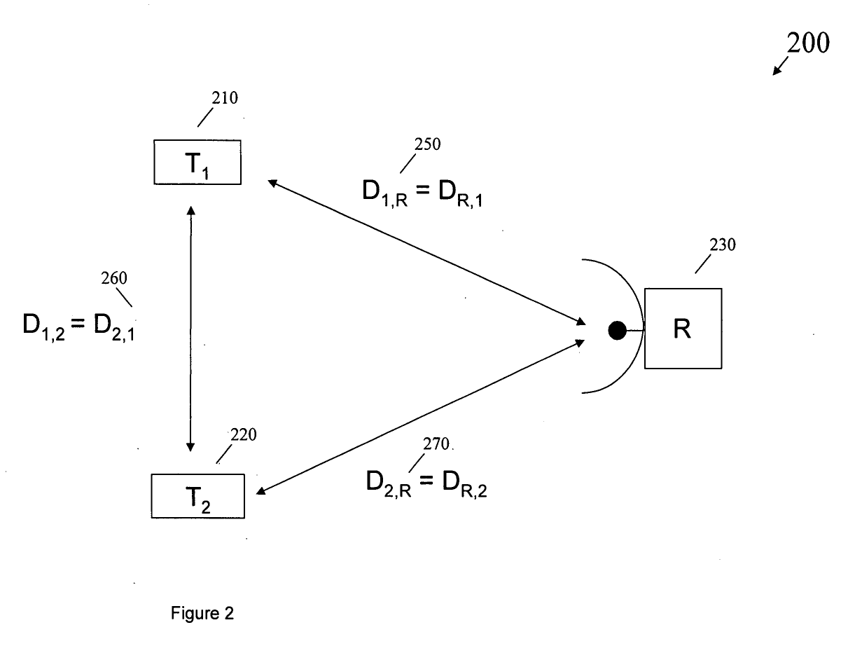

FIG. 2 200 displays an exemplary layout of two tags communicating with a reader. The reader R 230 sends a signal to tag T₁ 210 and to tag T₂ 220. The distance between the reader and tag T₁ is denoted D_{1,R} 250. The distance between the reader and tag T₂ is denoted D_{2,R} 270. The distance between tag T₁ and tag T₂ is denoted D_{1,2} 260.

The reader initiates communication by broadcasting a signal that is received by both tag T₁ and tag T₂. Upon receiving the signals, tags T₁ and T₂ record the receive distances D_{R,1} and D_{R2}, respectively. Each tag (T₁ and T₂) then broadcasts a signal that includes their respective initial receive distances. Tag T₁ receives the signal broadcast by tag T₂ and records the corresponding receive distance D_{1,2}. Similarly, Tag T₂ receives the signal broadcast by tag T₁ and records the corresponding receive distance D_{2,1}. Upon receiving these second signals, tags T₁ and T₂ record the corresponding receive distances, D_{1,2} and D_{2,1}. Each tag (T₁ and T₂) then broadcasts a signal that includes the recently recorded receive distances (D_{1,2} and D_{2,1}) as well as all previously recorded receive distances. The broadcast signals are received by the reader. All of the received distance information is used to calculate the physical locations of the tags with respect to the reader.

As shown in the exemplary embodiment of FIG. 2 200, upon completion of signal transmissions, the reader will receive values for the distance D_{R,1} between the reader and tag T₁, the distance D_{R,2} between the reader and tag T₂ and the distance D_{1,2} between tag T₁ and the distance D_{2,1} between tag T₂. Additionally, using the transmission of tag T₁ to itself, the reader can calculate the distance between tag T₁ to itself, D_{1,R}. In theory, this distance is the same as D_{R,1}, but in practice T₁ and R will calculate different values for their pair-wise, linear separation. Similarly, using the transmission of T₂ to itself, R can calculate D_{2,R}, the distance between tag T₂ and itself. Furthermore, due to redundancy in the signal broadcast scheme, the reader will receive multiple values for each of these distances D_{1,R}, D_{2,R}, D_{R,1}, D_{R,2}, D_{2,1} and D_{1,2} so that the corresponding values can be verified.

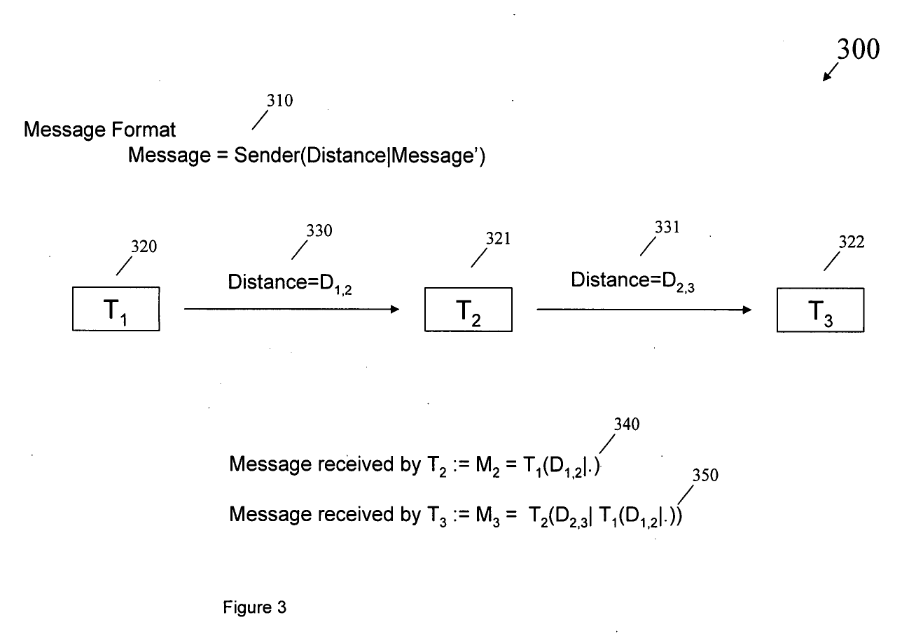

FIG. 3 300 displays an exemplary message format for recording and forwarding the received distances between tags and readers. The exemplary format shows that each outgoing message includes a payload of data that is formatted 310 as Sender(Distance|Message) where the Sender denotes the tag or reader ID of the tag or reader that is generating the message, where Distance denotes the received distance of the most recently received message, and Message denotes the message payload of the most recently received message. Consider the exemplary layout in FIG. 3 in which tag T₁ 320 sends a signal to tag T₂ 321 which, in turn, sends a signal to tag T₃ 322. The distance between tag T₁ and tag T₂ is denoted D_{1,2} 330 and the distance between tag T₂ and tag T₃ is denoted D_{2,3} 331. Using the exemplary message format described in the present invention, the message M₂ 340 received by tag T₂ from tag T₁ is M₂=T₁(D_{1,2}). Similarly, using the exemplary message format described herein, the message M₃ 350 received by tag T₃ from tag T₂ is M₃=T₂(D_{2,3}|T₁(D_{1,2})). The iterative message format involves concatenation of old data with new data and can continue in such manner indefinitely.

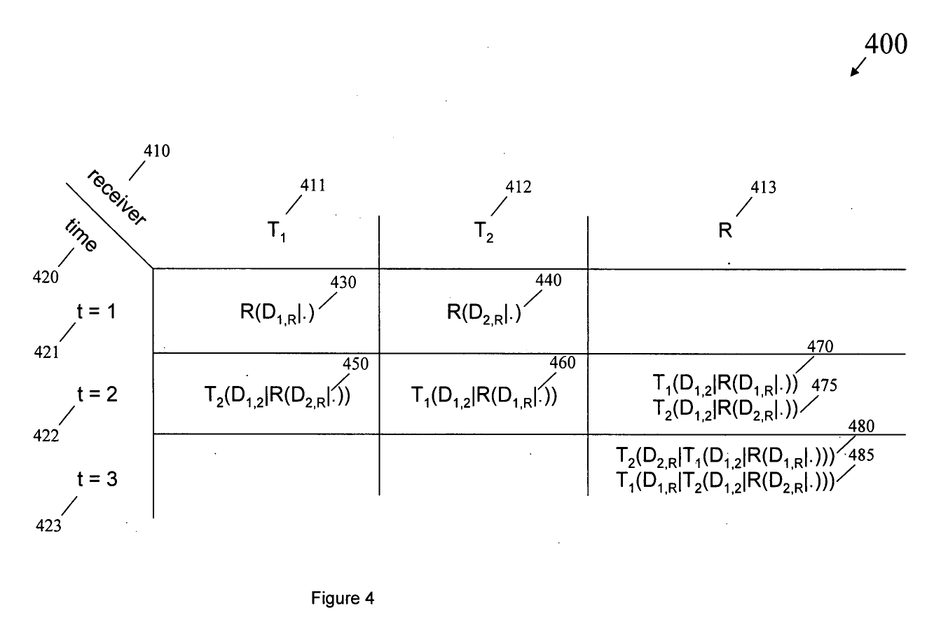

FIG. 4 400 illustrates a matrix chart for further describing the exemplary message format introduced in FIG. 3 300. Three entities (tag T₁ 411, tag T₂ 412 and reader R 413) can receive messages and serve as receiver 410 categories. Three time 420 periods are illustrated including time t=1 421, time t=2 422 and time t=3 423. At time t=0, the reader broadcasts an initial signal; the matrix shows received messages in response to the initial reader broadcast. At time period t=1, tag T₁ receives a message 430 formatted as R(D_{1,R}). At time period t=1, tag T₂ receives a message 440 formatted as R(D_{2,R}). At time period t=2, tag T₁ receives a message 450 formatted as T₂(D_{1,2}|R(D_{2,R})). At time period t=2, tag T₂ receives a message 460 formatted as T₁(D_{1,2}|R(D_{1,R})). At time period t=2, reader R receives one message 470 formatted as T₁(D_{1,2}|R(D_{1,R})) and another message 475 formatted as T₂(D_{1,2}|R(D_{2,R})). At time period t=3, reader R receives one message 480 formatted as T₂(D_{2,R|T}₁(D_{1,2}|R(D_{1,R}))) and another message 485 formatted as T₁(D_{1,R}|T₂(D_{1,2}|R(D_{2,R}))).

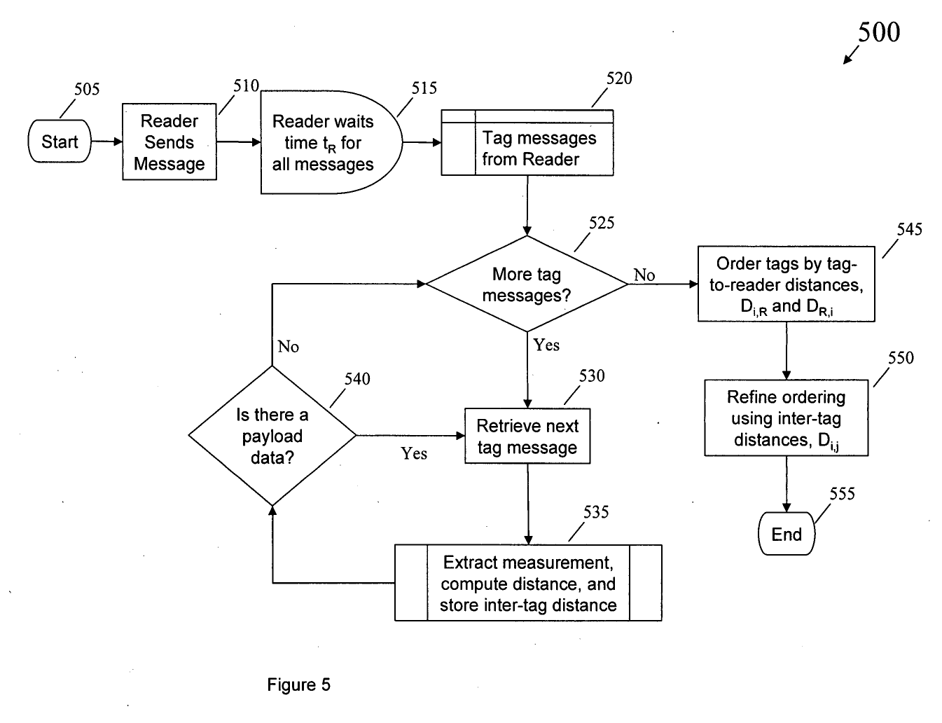

FIG. 5 illustrates a flowchart 500 for a method of for practicing the present invention. The method starts in step 505. A reader sends a message to one or more tags in its field-of-view 510. The reader then waits some time t_{R} for tag responses 515. All tag responses are then stored in memory 520. If there are more tag messages in memory 525 (“Yes” branch), then the next tag message is retrieved from memory for processing 530. From each tag message, a proximity measurement is extracted, a distance is calculated for each measurement, and the calculated distance is stored in memory for later use 535. If there is additional payload data in the tag message 540 (“Yes” branch), then steps 530 and 535 are iterated until the tag message is fully processed. If there is no additional payload data 540 (“No” branch), then steps 525, 530, 535, and 540 are iterated until there are no more tag messages from the reader stored in memory.

If there are no more tag messages in memory 525 (“No” branch), then enough information has been computed to determine the linear order of the responding tags relative to the readers position. As a first approximation, the tags are ordered by the computed tag-to-reader distances, D_{i,R}, and the reader-to-tag distances, D_{R,i}. This initial ordering is then further refined by considering the computed inter-tag distances, D_{i,j}, for all i>0 and j>0 555. Exemplary method 500 can be iterated any number of times to achieve the desired accuracy. As a further refinement, the reader transmit power can be varied (successively decreased) at each iteration. This technique would help refine which tags are closer to the reader.

Therefore, as shown above, the invention comprises a method of determining the physical ordering of radio frequency identification (RFID) tags. The transceiver broadcasts an inquiry radio signal to the plurality of RFID tags. In response to the inquiry radio signal, the RFID tags respond with first response radio signals that contain identifying information unique to each RFID tag and a measure of “first” physical distance between the transceiver and each the RFID tag. This first physical distance is based on the signal strength of the inquiry radio signal as received by each RFID tag, such that stronger inquiry radio signals are determined to be received by RFID tags that are closer to the transceiver and weaker inquiry radio signals are determined to be received by RFID tags that are farther from the transceiver.

The RFID tags process the first response radio signals received by the RFID tags to determine second physical distances between the RFID tags. Again, the second physical distances are based on the signal strength of each first response radio signal received by the RFID tags, such that stronger first response radio signals are determined to be sent by RFID tags that are closer to each other and weaker first response radio signals are determined to be sent by RFID tags that are farther from each other. The RFID tags simultaneously respond to the first response radio signals with second response radio signals that contain the measures of second physical distances between the RFID tags.

This allows the processor to calculate the physical ordering of the RFID tags based on the first physical distance and the second physical distances. All the foregoing broadcasting, the responding with the first response radio signals the processing, the responding with the second response radio signals, and the calculating can be repeated with a series of varying signal strength inquiry radio signals to refine the calculation of physical ordering of the RFID tags.

The processor can also process the first response radio signals received by the transceiver to provide a separate confirming calculation of the first physical distance between the transceiver and each the RFID tag. Similarly, this separate confirming calculation of the first physical distance is based on the signal strength of each first response radio signal received by the transceiver, such that stronger first response radio signals are determined to be sent by RFID tags that are closer to the transceiver and weaker first response radio signals are determined to be sent by RFID tags that are farther from the transceiver. The first physical distance mentioned above comprises a linear separation between the transceiver and the RFID tags and the second physical distances comprise linear separations between the RFID tags.

While the invention has been described in terms of several exemplary embodiments, those skilled in the art will recognize that the invention can be practiced with modification within the spirit and scope of the appended claims.

For example, this invention does not only apply to conveyor belt routing systems, but also to other systems, such as a supermarket's item expiration detection system. Similarly, the invention may also be practiced using active, semi-active, and/or semi-passive RFID tags.

Further, it is noted that, Applicants' intent is to encompass equivalents of all claim elements, even if amended later during prosecution.

What is claimed is:

1. A method of determining a physical ordering of radio frequency identification (RFID) tags, said method comprising:
broadcasting, by a transceiver, an inquiry radio signal to a plurality of RFID tags;
simultaneously responding, by said RFID tags, to said inquiry radio signal with first response radio signals comprising identifying information unique to each RFID tag and a measure of first physical distance between said transceiver and each said RFID tag, wherein said first physical distance is based on a signal strength of said inquiry radio signal as received by each RFID tag, such that stronger inquiry radio signals are determined to be received by RFID tags that are closer to said transceiver and weaker inquiry radio signals are determined to be received by RFID tags that are farther from said transceiver;
processing, by said RFID tags, said first response radio signals received by said RFID tags to determine second physical distances between said RFID tags, wherein said second physical distances are based on a signal strength of each first response radio signal received by said RFID tags, such that stronger first response radio signals are determined to be sent by RFID tags that are closer to each other and weaker first response radio signals are determined to be sent by RFID tags that are farther from each other;
simultaneously responding, by said RFID tags, to said first response radio signals with second response radio signals comprising said second physical distances between said RFID tags; and
calculating, by a processor connected to said transceiver, said physical ordering of said RFID tags based on said first physical distance and said second physical distances.

2. The method according to claim 1, further comprising processing, by said processor, said first response radio signals received by said transceiver to provide a separate confirming calculation of said first physical distance between said transceiver and each said RFID tag, wherein said separate confirming calculation of said first physical distance is based on a signal strength of each first response radio signal received by said transceiver, such that stronger first response radio signals are determined to be sent by RFID tags that are closer to said transceiver and weaker first response radio signals are determined to be sent by RFID tags that are farther from said transceiver.

3. The method according to claim 1, said first physical distance comprises a linear separation between said transceiver and said RFID tags and said second physical distances comprise linear separations between said RFID tags.

4. A method of determining a physical ordering of radio frequency identification (RFID) tags, said method comprising:
broadcasting, by a transceiver, an inquiry radio signal to a plurality of RFID tags;
simultaneously responding, by said RFID tags, to said inquiry radio signal with first response radio signals comprising identifying information unique to each RFID tag and a measure of first physical distance between said transceiver and each said RFID tag, wherein said first physical distance is based on a signal strength of said inquiry radio signal as received by each RFID tag, such that stronger inquiry radio signals are determined to be received by RFID tags that are closer to said transceiver and weaker inquiry radio signals are determined to be received by RFID tags that are farther from said transceiver;
processing, by said RFID tags, said first response radio signals received by said RFID tags to determine second physical distances between said RFID tags, wherein said second physical distances are based on a signal strength of each first response radio signal received by said RFID tags, such that stronger first response radio signals are determined to be sent by RFID tags that are closer to each other and weaker first response radio signals are determined to be sent by RFID tags that are farther from each other;
simultaneously responding, by said RFID tags, to said first response radio signals with second response radio signals comprising said second physical distances between said RFID tags;
calculating, by a processor connected to said transceiver, said physical ordering of said RFID tags based on said first physical distance and said second physical distances; and
repeating said broadcasting, said responding with said first response radio signals said processing, said responding with said second response radio signals, and said calculating with a series of varying signal strength inquiry radio signals to refine said physical ordering.

5. The method according to claim 4, further comprising processing, by said processor, said first response radio signals received by said transceiver to provide a separate confirming calculation of said first physical distance between said transceiver and each said RFID tag, wherein said separate confirming calculation of said first physical distance is based on a signal strength of each first response radio signal received by said transceiver, such that stronger first response radio signals are determined to be sent by RFID tags that are closer to said transceiver and weaker first response radio signals are determined to be sent by RFID tags that are farther from said transceiver.

6. The method according to claim 4, said first physical distance comprises a linear separation between said transceiver and said RFID tags and said second physical distances comprise linear separations between said RFID tags.
